(19) United States
(12) Patent Application Publication
(10) Pub. No.: US 2026/0018907 A1
(43) Pub. Date: Jan. 15, 2026

(54) System, Method, and Computer Program Product for Monitoring and Passive Balancing in Battery Pack Charging

(71) Applicant: Energizai, Inc., Vernon Hills, IL (US)

(72) Inventors: Yingying Fan, Hawthorn Woods, IL (US); Bowei Song, Hawthorn Woods, IL (US); Jingsong Xia, Hawthorn Woods, IL (US)

(21) Appl. No.: 19/269,628

(22) Filed: Jul. 15, 2025

Related U.S. Application Data
(60) Provisional application No. 63/671,450, filed on Jul. 15, 2024.

(51) Int. Cl. H02J 7/00

(52) U.S. Cl. CPC H02J 7/0014; H02J 7/0047; H02J 7/00712

(57) ABSTRACT

Systems, methods, and computer program products are provided for monitoring and passive balancing in battery pack charging. An example system includes a plurality of voltage detectors, a plurality of passive balancing circuits, a charging current detector, and a control circuit. The control circuit may be configured to receive a plurality of voltage measurements and a charging current measurement; determine based on a voltage measurement of the plurality of voltage measurements and/or the charging current measurement, whether to activate a passive balancing circuit of the plurality of passive balancing circuits to adjust the adjustable resistance of the passive balancing circuit; and adjust, based on a passive balance current measurement through the passive balancing circuit and the voltage measurement, the adjustable resistance of the passive balancing circuit.

### CROSS REFERENCE TO RELATED APPLICATION

The present application claims the benefit of U.S. Patent Provisional Application Ser. No. 63/671,450, filed Jul. 15, 2024, the entire disclosure of which is hereby incorporated by reference in its entirety.

### BACKGROUND

### Technical Field

This disclosure relates generally to battery pack charging and, in some non-limiting embodiments or aspects, to systems, methods, and computer program products for monitoring and passive balancing in battery pack charging.

### Technical Considerations

In various applications, such as electric vehicles and drones, battery packs are commonly created by connecting multiple batteries in series to achieve a required voltage. However, managing of the charging process of these packs may be performed due to the varying attributes of each battery, such as remaining capacity and temperature. Moreover, when batteries are charged in series, the batteries may reach the rated charging voltage at different rates, posing a safety risk if some batteries become overcharged. Therefore, effective battery management may be needed during the charging of series-connected battery packs. Battery management typically involves detecting battery voltage and current, controlling the battery charging stage, and implementing battery balancing management, which can be achieved through active or passive methods. Active balancing, which involves transferring excess power from some batteries to those with insufficient power, may be complex and costly to implement. On the other hand, passive balancing dissipates the excess power from fully charged batteries by adding extra resistors to the charging circuits, ensuring the batteries do not become overcharged and achieving balance within the battery pack.

Passive balancing battery management techniques may apply to various battery charging modes, including the widely used Constant Current Constant Voltage (CC-CV) method. In the CC-CV charging technique, the battery pack is initially charged with a constant current at a higher level, leading to a gradual increase in the voltage of each battery within the pack. As the battery voltage approaches a predetermined level, the charging process switches to constant voltage charging. Subsequently, the charging current gradually decreases until the charging current reaches a preset threshold, indicating the completion of the charging process.

During the CC-CV charging process, several issues may arise, one of which is determining an optimal timing to switch from constant current charging to constant voltage charging. Constant current charging delivers a significant amount of charge to the battery rapidly by utilizing a high charging current. However, because the charging speed of each battery within the battery pack may vary, delaying the switch to constant voltage charging can lead to some batteries reaching or exceeding their maximum voltage, resulting in overcharging and compromising battery safety and longevity. Consequently, monitoring the battery's condition and managing the charging stages may be components of a battery management system. Any errors in voltage and current detection or delays in feedback control can lead to insufficient battery protection.

During the constant voltage charging stage, one or more batteries in the battery pack may already be close to the pre-set voltage level. Applying a constant voltage to the entire battery pack may cause some batteries to exceed their safety threshold and result in overcharging. To safeguard these batteries, a battery balancing circuit may be implemented. A principle of passive balancing is that once activated, the circuit should consume any excess voltage from the ongoing voltage charging, allowing the battery to remain at a preset voltage level without being overcharged or discharged. However, existing passive balancing circuits typically consist of fixed-value resistors connected in parallel to the corresponding battery, meaning that the resistance and voltage/current-dissipating capability remain fixed. As a result, there may be instances where the voltage protection offered by the passive balancing circuit is lower than the port voltage of the battery, leading to overcharging.

China Patent Application Publication No. 102522788A discloses a battery management system and a method for controlling battery charging modes. The system comprises a microcontroller, a series-connected battery pack, a battery voltage detection module, and a balancing control module. The charging process is divided into normal charging and trickle charging modes. When the balancing control module activates during trickle charging, excess current is consumed by parallel resistors to balance the charge within the resistor group. However, this application does not address at least one issue: the parallel resistor still maintains a fixed resistance value, resulting in a fixed voltage generated by the passive balancing circuit (VP=R*I) during the constant current trickle charging stage. This fixed value cannot accommodate dynamic charging processes. For example, if the charged voltage (VT) of a battery is greater than the shunt voltage (VP), the battery will discharge to charge the passive balancing circuit. Conversely, if VT is less than VP, the battery will continue to charge, even the battery it has already reached the preset port voltage, potentially reducing battery safety or causing self-damage.

However, slight variations in terminal voltage can occur among batteries in a series configuration. These variations may arise due to manufacturing tolerances, differences in internal resistance, and uneven charging or discharging rates. Although the exact magnitude of variance depends on factors such as battery technology, quality control, and operating conditions, the variance typically ranges from a few millivolts to a few tenths of a volt. While this variance may appear small, the variance can accumulate over time and multiple charge-discharge cycles, potentially leading to imbalanced charging and discharging among the batteries in the pack.

### SUMMARY

Accordingly, provided are improved systems, methods, and computer program products for monitoring and passive balancing in battery pack charging. For example, non-limiting embodiments or aspects of the present disclosure may address and mitigate limitations caused by voltage variances to ensure that each battery is charged to a target value and inhibit or prevent repeated overcharging or discharging, thereby improving the safety, lifespan, and charging efficiency of a battery pack.

According to non-limiting embodiments or aspects, provided is a system including: a plurality of voltage detectors configured to determine a plurality of voltage measurements of a plurality voltages across a plurality of batteries connected in series; a plurality of passive balancing circuits, wherein each passive balancing circuit of the plurality of passive balancing circuits is configured to be connected in parallel to a battery of the plurality of batteries, and wherein each passive balancing circuit of the plurality of passive balancing circuits has an adjustable resistance and includes a passive balance current detector configured to determine a passive balance current measurement of a passive balance current through that passive balancing circuit; a charging current detector configured to determine a charging current measurement of a charging current through the plurality of batteries; and a control circuit configured to: receive the plurality of voltage measurements and the charging current measurement; and determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate a passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

In some non-limiting embodiments or aspects, the passive balancing circuit of the plurality of passive balancing circuits connected in parallel to the battery further includes: a plurality of resistors connected in parallel to each other and the battery; and a plurality of switches corresponding to the plurality of resistors, wherein each resistor of the plurality of resistors is connected in series to a switch of the plurality of switches, wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

In some non-limiting embodiments or aspects, the plurality of switches includes a plurality of metal-oxide-semiconductor field-effect transistors (MOSFETs).

In some non-limiting embodiments or aspects, the passive balancing circuit of the plurality of passive balancing circuits connected in parallel to the battery further includes: a variable resistor connected in parallel to the battery; and a switch connected in series to the variable resistor, wherein the control circuit is configured to adjust the adjustable resistance of the passive balancing circuit of the plurality of passive balancing circuits connected in parallel to the battery by: activating the switch of the passive balancing circuit; and controlling, based on the passive balance current measurement of the passive balance current through the passive balancing circuit and the voltage measurement of the plurality of voltages measurements of the voltage of the plurality of voltages measured across the battery of the plurality of batteries, the variable resistor to adjust the adjustable resistance of the passive balancing circuit.

In some non-limiting embodiments or aspects, the switch includes a metal-oxide-semiconductor field-effect transistors (MOSFET).

In some non-limiting embodiments or aspects, the passive balancing circuit of the plurality of passive balancing circuits connected in parallel to the battery further includes: a transistor connected in parallel to the battery; a resistor connected in series to the transistor; and a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage voltages measured across the battery of the plurality of batteries, the digital control signal provided to the DAC or the LPF to control the input voltage of the transistor via the analog output signal to adjust the adjustable resistance of the passive balancing circuit.

In some non-limiting embodiments or aspects, the passive balancing circuit of the plurality of passive balancing circuits connected in parallel to the battery further includes: a switch connected in series to the resistor, wherein the control circuit is configured to adjust the adjustable resistance of the passive balancing circuit of the plurality of passive balancing circuits connected in parallel to the battery by: activating the switch, wherein the switch includes a metal-oxide-semiconductor field-effect transistors (MOSFET).

In some non-limiting embodiments or aspects, the control circuit is configured to control charging of the plurality of batteries in a plurality of charging stages, wherein the control circuit is configured to control, based on a current charging stage of the plurality of charging stages, at least one of a current source, a voltage source, or any combination thereof to provide at least one of the charging current through the plurality of batteries, a charging voltage across the plurality of batteries, or any combination thereof, to charge the plurality of batteries, and wherein the control circuit is further configured to adjust the adjustable resistance of the passive balancing circuit of the plurality of passive balancing circuits connected in parallel to the battery based on the current charging stage of the plurality of charging stages.

In some non-limiting embodiments or aspects, the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

According to non-limiting embodiments or aspects, provided is a method including: receiving, with at least one processor, from a plurality of voltage detectors, a plurality of voltage measurements of a plurality voltages across a plurality of batteries connected in series; receiving, with the at least one processor, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance; receiving, with the at least one processor, from a charging current, a charging current measurement of a charging current through the plurality of batteries; determining, with the at least one processor, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjusting, with the at least one processor, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

In some non-limiting embodiments or aspects, the passive balancing circuit of the plurality of passive balancing circuits connected in parallel to the battery further includes: a plurality of resistors connected in parallel to each other and the battery; and a plurality of switches corresponding to the plurality of resistors, wherein each resistor of the plurality of resistors is connected in series to a switch of the plurality of switches, wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

In some non-limiting embodiments or aspects, the plurality of switches includes a plurality of metal-oxide-semiconductor field-effect transistors (MOSFETs).

In some non-limiting embodiments or aspects, the passive balancing circuit of the plurality of passive balancing circuits connected in parallel to the battery further includes: a variable resistor connected in parallel to the battery; and a switch connected in series to the variable resistor, wherein adjusting, with the at least one processor, the adjustable resistance of the passive balancing circuit of the plurality of passive balancing circuits connected in parallel to the battery includes: activating, with the at least one processor, the switch of the passive balancing circuit; and controlling, with the at least one processor, based on the passive balance current measurement of the passive balance current through the passive balancing circuit and the voltage measurement of the plurality of voltages measurements of the voltage of the plurality of voltages measured across the battery of the plurality of batteries, the variable resistor to adjust the adjustable resistance of the passive balancing circuit.

In some non-limiting embodiments or aspects, the switch includes a metal-oxide-semiconductor field-effect transistors (MOSFET).

In some non-limiting embodiments or aspects, the passive balancing circuit of the plurality of passive balancing circuits connected in parallel to the battery further includes: a transistor connected in parallel to the battery; a resistor connected in series to the transistor; and a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and wherein adjusting, with the at least one processor, the adjustable resistance of the passive balancing circuit of the plurality of passive balancing circuits connected in parallel to the battery includes: controlling, with the at least one processor, based on the passive balance current measurement of the passive balance current through the passive balancing circuit and the voltage measurement of the plurality of voltages measurements of the voltage of the plurality of voltages measured across the battery of the plurality of batteries, the digital control signal provided to the DAC or the LPF to control the input voltage of the transistor via the analog output signal to adjust the adjustable resistance of the passive balancing circuit.

In some non-limiting embodiments or aspects, the passive balancing circuit of the plurality of passive balancing circuits connected in parallel to the battery further includes: a switch connected in series to the resistor, wherein adjusting, with the at least one processor, the adjustable resistance of the passive balancing circuit of the plurality of passive balancing circuits connected in parallel to the battery includes: activating, with the at least one processor, the switch, wherein the switch includes a metal-oxide-semiconductor field-effect transistors (MOSFET).

In some non-limiting embodiments or aspects, the method further includes: controlling, with the at least one processor, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and wherein adjusting, with the at least one processor, the adjustable resistance of the passive balancing circuit of the plurality of passive balancing circuits connected in parallel to the battery is further based on the current charging stage of the plurality of charging stages.

In some non-limiting embodiments or aspects, the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

According to non-limiting embodiments or aspects, provided is a computer program product including a non-transitory computer readable medium including program instructions which, when executed by at least one processor, cause the at least one processor to: receive, from a plurality of voltage detectors, a plurality of voltage measurements of a plurality voltages across a plurality of batteries connected in series; receive, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance; receive, from a charging current, a charging current measurement of a charging current through the plurality of batteries; determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

In some non-limiting embodiments or aspects, the program instructions, when executed by the at least one processor, further cause the at least one processor to: control, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and wherein adjusting the adjustable resistance of the passive balancing circuit of the plurality of passive balancing circuits connected in parallel to the battery is further based on the current charging stage of the plurality of charging stages.

Further non-limiting embodiments or aspects are set forth in the following numbered clauses:

Clause 1. A system comprising: a plurality of voltage detectors configured to determine a plurality of voltage measurements of a plurality voltages across a plurality of batteries connected in series; a plurality of passive balancing circuits, wherein each passive balancing circuit of the plurality of passive balancing circuits is configured to be connected in parallel to a battery of the plurality of batteries, and wherein each passive balancing circuit of the plurality of passive balancing circuits has an adjustable resistance and includes a passive balance current detector configured to determine a passive balance current measurement of a passive balance current through that passive balancing circuit; a charging current detector configured to determine a charging current measurement of a charging current through the plurality of batteries; and a control circuit configured to: receive the plurality of voltage measurements and the charging current measurement; and determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate a passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

Clause 2. The system of clause 1, wherein the passive balancing circuit of the plurality of passive balancing circuits connected in parallel to the battery further includes: a plurality of resistors connected in parallel to each other and the battery; and a plurality of switches corresponding to the plurality of resistors, wherein each resistor of the plurality of resistors is connected in series to a switch of the plurality of switches, wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

Clause 3. The system of clause 1 or 2, wherein the plurality of switches includes a plurality of metal-oxide-semiconductor field-effect transistors (MOSFETs).

Clause 4. The system of any of clauses 1-3, wherein the passive balancing circuit of the plurality of passive balancing circuits connected in parallel to the battery further includes: a variable resistor connected in parallel to the battery; and a switch connected in series to the variable resistor, wherein the control circuit is configured to adjust the adjustable resistance of the passive balancing circuit of the plurality of passive balancing circuits connected in parallel to the battery by: activating the switch of the passive balancing circuit; and controlling, based on the passive balance current measurement of the passive balance current through the passive balancing circuit and the voltage measurement of the plurality of voltages measurements of the voltage of the plurality of voltages measured across the battery of the plurality of batteries, the variable resistor to adjust the adjustable resistance of the passive balancing circuit.

Clause 5. The system of any of clauses 1-4, wherein the switch includes a metal-oxide-semiconductor field-effect transistors (MOSFET).

Clause 6. The system of any of clauses 1-5, wherein the passive balancing circuit of the plurality of passive balancing circuits connected in parallel to the battery further includes: a transistor connected in parallel to the battery; a resistor connected in series to the transistor; and a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage measurement of the plurality of voltages measurements of the voltage of the plurality of voltages measured across the battery of the plurality of batteries, the digital control signal provided to the DAC or the LPF to control the input voltage of the transistor via the analog output signal to adjust the adjustable resistance of the passive balancing circuit.

Clause 7. The system of any of clauses 1-6, wherein the passive balancing circuit of the plurality of passive balancing circuits connected in parallel to the battery further includes: a switch connected in series to the resistor, wherein the control circuit is configured to adjust the adjustable resistance of the passive balancing circuit of the plurality of passive balancing circuits connected in parallel to the battery by: activating the switch, wherein the switch includes a metal-oxide-semiconductor field-effect transistors (MOSFET).

Clause 8. The system of any of clauses 1-7, wherein the control circuit is configured to control charging of the plurality of batteries in a plurality of charging stages, wherein the control circuit is configured to control, based on a current charging stage of the plurality of charging stages, at least one of a current source, a voltage source, or any combination thereof to provide at least one of the charging current through the plurality of batteries, a charging voltage across the plurality of batteries, or any combination thereof, to charge the plurality of batteries, and wherein the control circuit is further configured to adjust the adjustable resistance of the passive balancing circuit of the plurality of passive balancing circuits connected in parallel to the battery based on the current charging stage of the plurality of charging stages.

Clause 9. The system of any of clauses 1-8, wherein the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

Clause 10. A method comprising: receiving, with at least one processor, from a plurality of voltage detectors, a plurality of voltage measurements of a plurality voltages across a plurality of batteries connected in series; receiving, with the at least one processor, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance; receiving, with the at least one processor, from a charging current, a charging current measurement of a charging current through the plurality of batteries; determining, with the at least one processor, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjusting, with the at least one processor, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

Clause 11. The method of clause 10, wherein the passive balancing circuit of the plurality of passive balancing circuits connected in parallel to the battery further includes: a plurality of resistors connected in parallel to each other and the battery; and a plurality of switches corresponding to the plurality of resistors, wherein each resistor of the plurality of resistors is connected in series to a switch of the plurality of switches, wherein the control circuit is configured to adjust the adjustable resistance of the passive balancing circuit of the plurality of passive balancing circuits connected in parallel to the battery by: controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

Clause 12. The method of clause 10 or 11, wherein the plurality of switches includes a plurality of metal-oxide-semiconductor field-effect transistors (MOSFETs).

Clause 13. The method of any of clauses 10-12, wherein the passive balancing circuit of the plurality of passive balancing circuits connected in parallel to the battery further includes: a variable resistor connected in parallel to the battery; and a switch connected in series to the variable resistor, wherein adjusting, with the at least one processor, the adjustable resistance of the passive balancing circuit of the plurality of passive balancing circuits connected in parallel to the battery includes: activating, with the at least one processor, the switch of the passive balancing circuit; and controlling, with the at least one processor, based on the passive balance current measurement of the passive balance current through the passive balancing circuit and the voltage voltages measured across the battery of the plurality of batteries, the variable resistor to adjust the adjustable resistance of the passive balancing circuit.

Clause 14. The method of any of clauses 10-13, wherein the switch includes a metal-oxide-semiconductor field-effect transistors (MOSFET).

Clause 15. The method of any of clauses 10-14, wherein the passive balancing circuit of the plurality of passive balancing circuits connected in parallel to the battery further includes: a transistor connected in parallel to the battery; a resistor connected in series to the transistor; and a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and wherein adjusting, with the at least one processor, the adjustable resistance of the passive balancing circuit of the plurality of passive balancing circuits connected in parallel to the battery includes: controlling, with the at least one processor, based on the passive balance current measurement of the passive balance current through the passive balancing circuit and the voltage measurement of the plurality of voltages measurements of the voltage of the plurality of voltages measured across the battery of the plurality of batteries, the digital control signal provided to the DAC or the LPF to control the input voltage of the transistor via the analog output signal to adjust the adjustable resistance of the passive balancing circuit.

Clause 16. The method of any of clauses 10-15, wherein the passive balancing circuit of the plurality of passive balancing circuits connected in parallel to the battery further includes: a switch connected in series to the resistor, wherein adjusting, with the at least one processor, the adjustable resistance of the passive balancing circuit of the plurality of passive balancing circuits connected in parallel to the battery includes: activating, with the at least one processor, the switch, wherein the switch includes a metal-oxide-semiconductor field-effect transistors (MOSFET).

Clause 17. The method of any of clauses 10-16, further comprising: controlling, with the at least one processor, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and wherein adjusting, with the at least one processor, the adjustable resistance of the passive balancing circuit of the plurality of passive balancing circuits connected in parallel to the battery is further based on the current charging stage of the plurality of charging stages.

Clause 18. The method of any of clauses 10-17, wherein the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof

Clause 19. A computer program product including a non-transitory computer readable medium including program instructions which, when executed by at least one processor, cause the at least one processor to: receive, from a plurality of voltage detectors, a plurality of voltage measurements of a plurality voltages across a plurality of batteries connected in series; receive, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance; receive, from a charging current, a charging current measurement of a charging current through the plurality of batteries; determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

Clause 20. The computer program product of clause 19, wherein the program instructions, when executed by the at least one processor, further cause the at least one processor to: control, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and wherein adjusting the adjustable resistance of the passive balancing circuit of the plurality of passive balancing circuits connected in parallel to the battery is further based on the current charging stage of the plurality of charging stages.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1A is a block diagram of a system for monitoring and passive balancing in battery pack charging, according to some non-limiting embodiments or aspects;

FIG. 1B is a schematic diagram of example components of a system for monitoring and passive balancing in battery pack charging of FIG. 1A, according to some non-limiting embodiments or aspects;

FIG. 2 is a schematic diagram of example components of one or more devices or systems of FIGS. 1A and 1B, according to some non-limiting embodiments or aspects;

FIG. 3 is a schematic diagram of an implementation of a system for monitoring and passive balancing in battery pack charging, according to some non-limiting embodiments or aspects;

FIG. 4 is a schematic diagram of a further implementation of a system for monitoring and passive balancing in battery pack charging, according to some non-limiting embodiments or aspects;

FIG. 5 is a schematic diagram of a still further implementation of a system for monitoring and passive balancing in battery pack charging, according to some non-limiting embodiments or aspects; and

FIG. 6 is a flow diagram of a method for monitoring and passive balancing in battery pack charging, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the present disclosure provide systems, methods, and computer program products for monitoring and passive balancing in battery pack charging. An example system may include a plurality of voltage detectors, a plurality of passive balancing circuits, a charging current detector, and/or a control circuit. The plurality of voltage detectors may be configured to determine a plurality of voltage measurements of a plurality voltages across a plurality of batteries connected in series. The plurality of passive balancing circuits may correspond to the plurality of batteries, and each battery of the plurality of batteries may be connected in parallel to a passive balancing circuit of the plurality of passive balancing circuits. The charging current detector may be configured to determine a charging current measurement of a charging current through the plurality of batteries The control circuit may be configured to: receive the plurality of voltage measurements and the charging current measurement; and control, based on at least one of the following: a voltage measurement of the plurality of voltages measurements of a voltage of the plurality of voltages measured across a battery of the plurality of batteries, the charging current measurement of the charging current measured through the plurality of batteries, or any combination thereof, an activation of a passive balancing circuit of the plurality of passive balancing circuits connected in parallel to the battery.

In this way, non-limiting embodiments or aspects of the present disclosure may utilize voltage and current detection modules to monitor a status of each battery of a battery pack during a charging process. By analyzing and comparing this voltage and current information, a control circuit may activate a passive balance circuit with dynamic resistance values for a battery that satisfies one or more preset voltage and/or current conditions, which may ensure that each battery in the series is neither overcharged nor discharged, providing safety protection and balancing for the battery pack.

Enhanced safety measures provided by non-limiting embodiments or aspects of the present disclosure may have wide-ranging implications beyond the batteries themselves. In automotive applications, where series-connected battery packs are commonly used, precise balancing of each battery's voltage may inhibit or prevent potential hazards such as overcharging, which can lead to battery damage, reduced performance, and even the risk of fire. Moreover, in critical systems like healthcare and hospital equipment, where battery-powered devices are crucial, maintaining stability and optimal performance through effective balancing safeguards against unexpected failures ensures uninterrupted operation. The safety-focused approach of non-limiting embodiments or aspects of the present disclosure may not only extend battery lifespan, but may also contribute to overall automotive safety, personal safety, and the reliability of vital equipment in various industries.

Non-limiting embodiments or aspects of the present disclosure may employ a control circuit (e.g., microprocessor, a microcontroller, etc.) to monitor and analyze the status of each battery during charging. With a preset charging strategy, the control circuit may intelligently control the activation and deactivation of each passive balance circuit and the switching of charging stages, enhancing charging efficiency and safety, and a detection of the battery pack's voltage and current may enable timely adjustment of the charging stage based thereon, thereby enabling speeding up the charging process.

Compared to existing technologies, non-limiting embodiments or aspects of the present disclosure offer several advantages, including utilization of a passive balance circuit with dynamic resistance values, which adaptively adjusts resistance based on different charging conditions and battery states, achieving more precise and effective passive balancing. A simple and reliable hardware structure and software algorithm may be easy to implement, maintain, and have a low cost. Non-limiting embodiments or aspects of the present disclosure can be applied to various types and specifications of series-connected battery packs.

Implementing non-limiting embodiments or aspects of the present disclosure may include an initial investment in the charging management system, including a microprocessor, voltage detectors, passive balancing circuits, and/or associated components. While an upfront cost may vary depending on a specific application and scale, the long-term savings and benefits across different market sectors may be provided. In the automotive industry, where battery packs are extensively used, an efficient and safe charging system leads to significant cost savings by inhibiting or preventing battery damage, reducing the need for premature replacements, and minimizing the risk of accidents or fire hazards associated with unbalanced batteries. Moreover, in the healthcare sector, non-limiting embodiments or aspects of the present disclosure may ensure uninterrupted operation, reducing or preventing costly downtime and potential disruptions in patient care. Industrial applications also benefit from improved battery lifespan and optimized charging, resulting in reduced maintenance and replacement costs. Even in educational institutions, where battery-powered devices are utilized, non-limiting embodiments or aspects of the present disclosure may offer cost savings by extending the longevity of batteries and minimizing the need for frequent replacements. Overall, while considering the initial implementation cost, the estimated return on investment (ROI) in terms of increased safety, extended battery lifespan, reduced maintenance expenses, and enhanced operational reliability makes non-limiting embodiments or aspects of the present disclosure a valuable and cost-effective solution across multiple market sectors.

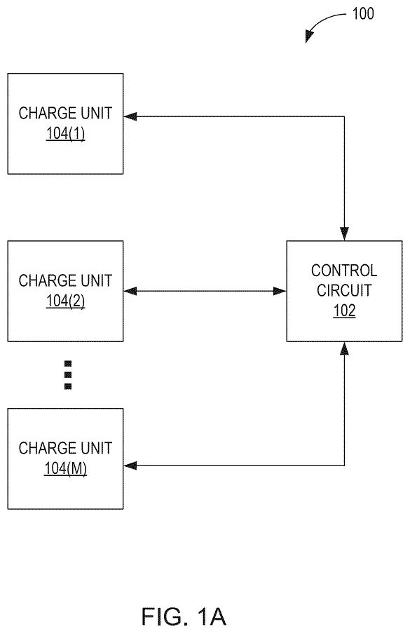

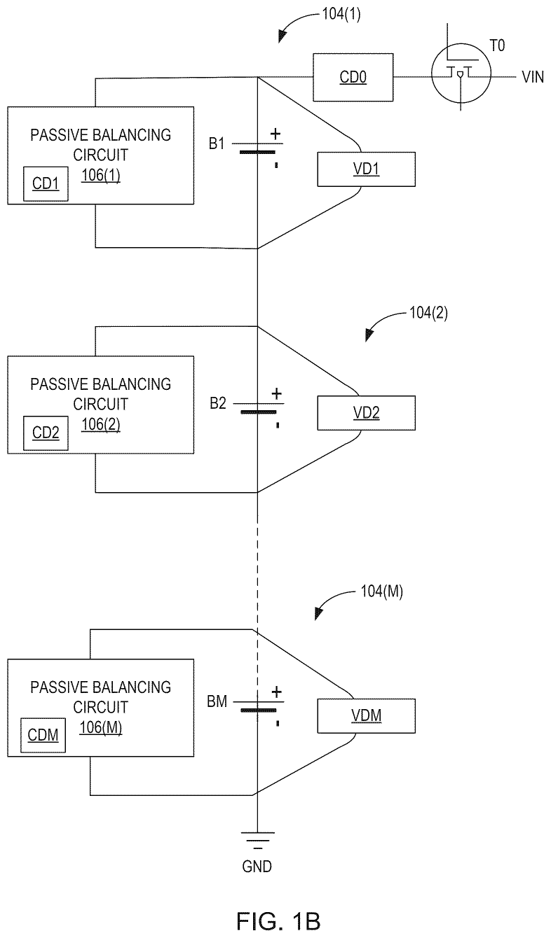

Referring now to FIG. 1A, shown is a schematic diagram of a system for monitoring and passive balancing in battery pack charging, according to some non-limiting embodiments or aspects. As shown in FIG. 1A, system 100 may include control circuit 102 and/or a plurality of charge units 104(1), 104(2), . . . 104(M). Systems and/or devices of system 100 can interconnect via wired connections, wireless connections, or a combination of wired and wireless connections.

Control circuit 102 may include a processor, a computing device, or the like. A processor may include a processor (e.g., a central processing unit (CPU), a graphics processing unit (GPU), an accelerated processing unit (APU), etc.), a microprocessor, a microcontroller, a digital signal processor (DSP), or any processing component (e.g., a field-programmable gate array (FPGA), an application-specific integrated circuit (ASIC), etc.) that can be programmed to perform a function.

Referring also to FIG. 1B, which is a schematic diagram of example components of system 100, according to some non-limiting embodiments or aspects, the plurality of charge units 104(1), 104(2), . . . 104(M) may be configured to receive a plurality of batteries B1, B2, . . . BM. When received within the plurality of charge units 104(1), 104(2), . . . 104(M), the plurality of batteries B1, B2, . . . BM may be connected in series, for example, via terminals of the plurality of charge units 104(1), 104(2), . . . 104(M) and/or terminals of the plurality of batteries B1, B2, . . . BM. As used herein, the term “battery pack” may refer to the plurality of batteries B1, B2, . . . BM connected in series.

Still referring to FIG. 1B, system 100 may further include charging current switch T0 (e.g., a metal-oxide-semiconductor field-effect transistor (MOSFET), etc.) and/or charging current detector CD0. Control circuit 102 may be configured to control charging current switch T0 (e.g., to open switch T0, to close switch T0, etc.) to control a connection of the plurality of batteries B1, B2, . . . BM connected in series to charging interface or voltage source Vin for charging the plurality of batteries B1, B2, . . . BM. For example, to achieve a desired battery pack voltage, the plurality of batteries B1, B2, . . . BM is connected in series, and charging interface or voltage source Vin may charge the entire battery pack via charging wires. Charging current detector CD0 may be configured to determine a charging current measurement of a charging current through the plurality of batteries B1, B2, . . . BM connected in series. For example, charging current detector CD0 may be connected in series with the plurality of batteries B1, B2, . . . BM to detect the charging current.

The plurality of charge units 104(1), 104(2), . . . 104(M) may include a plurality of voltage detectors VD1, VD2 . . . VDM and/or a plurality of passive balancing circuits 106(1), 106(2), . . . 106(M).

The plurality of voltage detectors VD1, VD2 . . . VDM may be configured to determine a plurality of voltage measurements of a plurality voltages across the plurality of batteries B1, B2, . . . BM connected in series. For example, each battery of the plurality of batteries B1, B2, . . . BM may be connected in parallel to a voltage detector of the plurality of voltage detectors VD1, VD2 . . . VDM, and the voltage detector of the plurality of voltage detectors VD1, VD2 . . . VDM connected in parallel to that battery may be configured to determine a voltage measurement of a voltage across that battery. As an example, the plurality of voltage detectors VD1, VD2 . . . VDM may measure a terminal voltage of each battery and communicate the measured voltages to control circuit 102.

The plurality of passive balancing circuits 106(1), 106(2), . . . 106(M) may correspond to the plurality of voltage detectors VD1, VD2 . . . VDM and/or the plurality of batteries B1, B2, . . . BM. For example, each passive balancing circuit of the plurality of passive balancing circuits 106(1), 106(2), . . . 106(M) may be configured to be connected in parallel to a battery of the plurality of batteries B1, B2, . . . BM. The plurality of passive balancing circuits 106(1), 106(2), . . . 106(M) may have a plurality of adjustable resistances and/or include a plurality of passive balance current detectors CD1, CD2, . . . CDM. For example, each passive balancing circuit of the plurality of passive balancing circuits 106(1), 106(2), . . . 106(M) may have adjustable resistance of the plurality of adjustable resistances and/or include a passive balance current detector of the plurality of passive balance current detectors CD1, CD2, . . . CDM., and the passive balance current detector of the plurality of passive balancing circuits 106(1), 106(2), . . . 106(M) may configured to determine a passive balance current measurement of a passive balance current through that passive balancing circuit. A passive balancing circuit of the plurality of passive balancing circuits 106(1), 106(2), . . . 106(M) may be configured to provide passive balancing protection to a corresponding battery of the plurality of batteries B1, B2, . . . BM when activated (e.g., when electrically connected to a corresponding battery, when a circuit between the passive balancing circuit and the corresponding battery is closed, etc.).

Control circuit 102 may be configured to receive (e.g., continually receive, periodically receive, etc.) the plurality of voltage measurements and the charging current measurement. For example, control circuit 102 may be configured to receive the plurality of voltage measurements from the plurality of voltage detectors VD1, VD2 . . . VDM. As an example, control circuit 102 may be configured to receive the charging current measurement from charging current detector CD0. Control circuit 102 may be configured to determine, based on at least one of the following: a voltage measurement of the plurality of voltages measurements of a voltage of the plurality of voltages measured across a battery of the plurality of batteries B1, B2, . . . BM, the charging current measurement of the charging current measured through the plurality of batteries B1, B2, . . . BM, or any combination thereof, whether to activate a passive balancing circuit of the plurality of passive balancing circuits 106(1), 106(2), . . . 106(M) connected in parallel to the battery to adjust the adjustable resistance of the passive balancing circuit. In response to determining to activate the passive balancing circuit of the plurality of passive balancing circuits 106(1), 106(2), . . . 106(M) connected in parallel to the battery to adjust the adjustable resistance of the passive balancing circuit, control circuit 102 may be configured to adjust, based on the passive balance current measurement of the passive balance current through the passive balancing circuit and/or the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery. In this way, control circuit 102 may manage and monitor an entire charging process by receiving voltage and current measurements and controlling charging stages, charging modes, charging amounts, and when to activate one or more of the plurality of passive balancing circuits 106(1), 106(2), . . . 106(M).

In some non-limiting embodiments or aspects, control circuit 102 is configured to charge the plurality of batteries B1, B2, . . . BM in a plurality of charging stages. Control circuit 102 may be configured to control, based on a current charging stage of the plurality of charging stages, at least one of a current source, a voltage source, or any combination thereof (e.g., charging interface or voltage source Vin, etc.) to provide at least one of the charging current through the plurality of batteries B1, B2, . . . BM, a charging voltage across the plurality of batteries B1, B2, . . . BM, or any combination thereof, to charge the plurality of batteries B1, B2, . . . BM according to parameters of the current charging stage. Control circuit 102 may be configured to set switching conditions for each charging stage of the plurality of charging stages and perform real-time detection and timely switching of the charging stages. The plurality of charging stages may include at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

Control circuit 102 may be further configured to adjust the adjustable resistance of the passive balancing circuit of the plurality of passive balancing circuits 106(1), 106(2), . . . 106(M) connected in parallel to the battery based on the current charging stage of the plurality of charging stages. For example, control circuit 102 may be configured to set, based on a current charging stage, predefined conditions or thresholds for each passive balancing circuit of the plurality of passive balancing circuits 106(1), 106(2), . . . 106(M) and compare the predefined conditions or thresholds to the plurality of voltage measurements and the charging current measurement to determine whether to activate a passive balancing circuit of the plurality of passive balancing circuits 106(1), 106(2), . . . 106(M) connected in parallel to the battery to adjust the adjustable resistance of the passive balancing circuit. As an example, depending on a current charging stage, the predefined conditions or thresholds can be based on reaching at least one of a preset voltage value, a preset current value, or any combination thereof. The activation condition for each passive balancing circuit can be uniform or varied, depending on the requirements, or the condition of each battery.

The number and arrangement of systems and devices shown in FIGS. 1A-1B are provided as an example. There may be additional systems or devices, fewer systems or devices, different systems or devices, or differently arranged systems or devices than those shown in FIGS. 1A-1B. Furthermore, two or more systems or devices shown in FIGS. 1A-1B may be implemented within a single system or device, or a single system or device shown in FIGS. 1A-1B may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

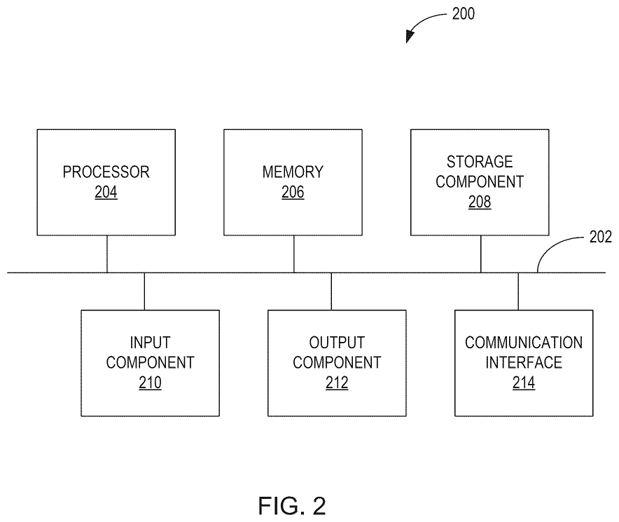

Referring now to FIG. 2, shown is a diagram of example components of a device 200 according to non-limiting embodiments. Device 200 may correspond to control circuit 102 in FIG. 1A, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), or any processing component (e.g., a field-programmable gate array (FPGA), an application-specific integrated circuit (ASIC), etc.) that can be programmed to perform a function. Memory 206 may include random access memory (RAM), read only memory (ROM), or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, or the like.

Device 200 may perform one or more processes described herein. Device 200 may perform these processes based on processor 204 executing software instructions stored by a computer-readable medium, such as memory 206 or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to a specific arrangement of software, device(s), or hardware for performing or enabling one or more of the innovative functions (e.g., actions, processes, steps of a process, or the like) described herein. For example, “a processor configured to” may refer to a processor that executes specific software instructions (e.g., program code) that cause the processor to perform one or more functions related to monitoring and passive balancing in battery pack charging.

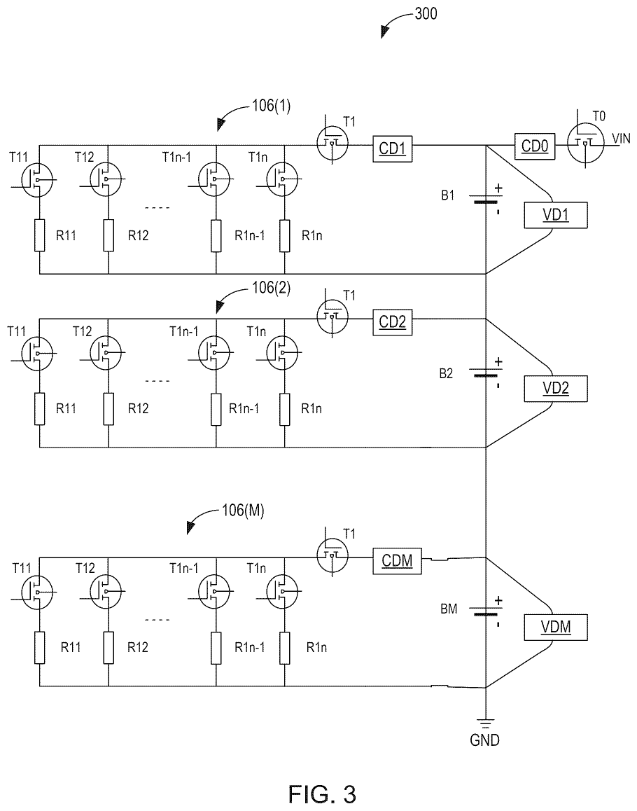

FIG. 3 is a schematic diagram of an implementation 300 of a system for monitoring and passive balancing in battery pack charging according to some non-limiting embodiments or aspects.

As shown FIG. 3, a passive balancing circuit of the plurality of passive balancing circuits 106(1), 106(2), . . . 106(M) (e.g., each passive balancing circuit of the plurality of passive balancing circuits 106(1), 106(2), . . . 106(M), etc.) may further include a plurality of resistors R11, R12, . . . R1n-1, R1n (e.g., a plurality of fixed resistors, a resistor matrix, etc.), a plurality of switches T11, T12, . . . T1n-1, T1n (e.g., a plurality of MOSFETs, etc.) corresponding to the plurality of resistors R11, R12, . . . R1n-1, R1n, and/or a main switch T1 (e.g., a main MOSFET, etc.). The plurality of resistors R11, R12, . . . R1n-1, R1n may be connected in parallel to each other (e.g., as a resistor matrix, etc.) and the battery of that passive balancing circuit. Each resistor of the plurality of resistors R11, R12, . . . R1n-1, R1n of that passive balancing circuit may be connected in series to a switch of the plurality of switches T11, T12, . . . T1n-1, T1n of that passive balancing circuit. For example, switches of the plurality of switches T11, T12, . . . T1n-1, T1n may be configured to connect or disconnect corresponding resistors of the plurality of resistors R11, R12, . . . R1n-1, R1n of that passive balancing circuit based on controls signals received from control circuit 102 to adjust the adjustable resistance of the passive balancing circuit.

In some non-limiting embodiments or aspects, resistance values of the plurality of resistors R11, R12, . . . R1n-1, R1n of a passive balancing circuit may be selected to achieve a desired level of accuracy. For example, the resistance values of the plurality of resistors R11, R12, . . . R1n-1, R1n may follow a pattern such as R1=2*R2=4*R3= . . . =2n-1*Rn, where each subsequent resistor of the plurality of resistors R11, R12, . . . R1n-1, R1n has a resistance value half that of the previous one.

It is noted that main switch T1 may be optional because each resistor of the plurality of resistors R11, R12, . . . R1n-1, R1n already corresponds to a switch of the plurality of switches T11, T12, . . . T1n-1, T1n. If each switch of the plurality of switches T11, T12, . . . T1n-1, T1n is turned off, it is electrically equivalent to turning off the main switch T1. Therefore, the main switch T1 may be considered optional.

Still referring to FIG. 3, control circuit 102 may be configured to adjust the adjustable resistance of a passive balancing circuit of the plurality of passive balancing circuits 106(1), 106(2), . . . 106(M) connected in parallel to a battery of the plurality of batteries B1, B2, . . . BM by: controlling, based on the passive balance current measurement of the passive balance current through the passive balancing circuit and/or the voltage measurement of the plurality of voltages measurements of the voltage of the plurality of voltages measured across the battery of the plurality of batteries B1, B2, . . . BM, the plurality of switches T11, T12, . . . T1n-1, T1n to adjust the adjustable resistance of the passive balancing circuit. For example, control circuit 102 may determine an activation time for the passive balancing circuit by calculating when the terminal voltage (VT) of a battery connected in parallel to that passive balancing circuit satisfies a predefined threshold. As an example, control circuit 102 may continually receive the passive balance current measurement of the passive balance current through that passive balancing circuit from the corresponding passive balance current detector of the plurality of passive balance current detectors CD1, CD2, . . . CDM that measures the passive balance current (e.g., Iₘ, 1≤m≤M, etc.) of the corresponding passive balancing circuit and/or the plurality of voltage measurements from the plurality of voltage detectors VD1, VD2, . . . VDM and continually calculate, based thereon, the adjustable resistance of that passive balancing circuit to provide via the plurality of resistors R11, R12, . . . R1n-1, R1n off that passive balancing circuit (e.g., an adjustable or equivalent resistance to provide via the resistor matrix (Rₘ=V_{Tm}/Iₘ), etc.). By controlling the resistor matrix, control circuit 102 may continually adjust the resistor matrix to achieve the calculated adjustable or equivalent resistance of Rm for the passive balancing circuit. This dynamic adjustment capability empowers the passive balancing circuit to efficiently consume excess energy, protect the battery, and ensure a balanced state, irrespective of the battery's current and voltage conditions.

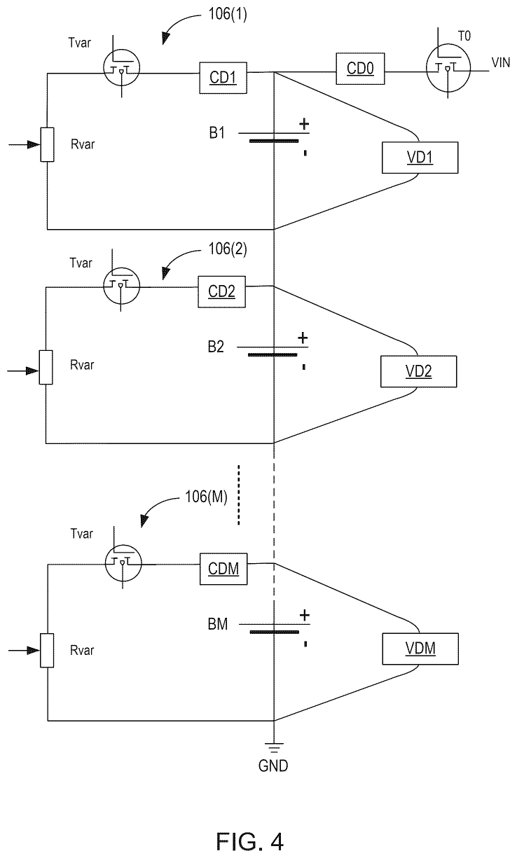

FIG. 4 is a schematic diagram of a further implementation 400 of a system for monitoring and passive balancing in battery pack charging according to some non-limiting embodiments or aspects.

As shown FIG. 4, a passive balancing circuit of the plurality of passive balancing circuits 106(1), 106(2), . . . 106(M) (e.g., each passive balancing circuit of the plurality of passive balancing circuits 106(1), 106(2), . . . 106(M), etc.) may further include a variable resistor Rvar and/or a switch Tvar. The variable resistor Rvar may be connected in parallel to the battery of that passive balancing circuit, and the switch Tvar may be connected in series to the variable resistor Rvar. The switch Tvar may include a MOSFET. The variable resistor Rvar may be configured to adjust its resistance value in response to controls signals received from control circuit 102 to adjust the adjustable resistance of the passive balancing circuit. For example, further implementation 400 of FIG. 4 may the same as or similar to implementation 300 shown in FIG. 3 except that the plurality of resistors R11, R12, . . . R1n-1, R1n or resistor matrix may be replaced with the variable resistor Rvar.

Still referring to FIG. 4, control circuit 102 may be configured to adjust the adjustable resistance of a passive balancing circuit of the plurality of passive balancing circuits 106(1), 106(2), . . . 106(M) connected in parallel to a battery of the plurality of batteries B1, B2, . . . BM by: activating (e.g., closing, etc.) the switch Tvar of the passive balancing circuit; and controlling, based on the passive balance current measurement of the passive balance current through the passive balancing circuit and/or the voltage measurement of the plurality of voltage measurements of the voltage of the plurality of voltages measured across the battery of the plurality of batteries B1, B2, . . . BM, the variable resistor Rvar to adjust the adjustable resistance of the passive balancing circuit. For example, control circuit 102 may continually receive the passive balance current measurement of the passive balance current through that passive balancing circuit from the corresponding passive balance current detector of the plurality of passive balance current detectors CD1, CD2, . . . CDM that measures the passive balance current (e.g., Iₘ, 1≤m≤M, etc.) of the corresponding passive balancing circuit and/or the plurality of voltage measurements from the plurality of voltage detectors VD1, VD2, . . . VDM and continually calculate the adjustable resistance of that passive balancing circuit to provide via the variable resistor Rvar of that passive balancing circuit. By controlling the variable resistor Rvar, control circuit 102 may continually adjust the resistance value of the variable resistor Rvar to achieve the calculated adjustable or equivalent resistance of Rm for the passive balancing circuit. Accordingly, non-limiting embodiments or aspects of the present disclosure may simplify the hardware structure of the passive balancing circuit and enable more precise balancing control while providing dynamic adjustment capability that empowers the passive balancing circuit to efficiently consume excess energy, protect the battery, and ensure a balanced state, irrespective of the battery's current and voltage conditions.

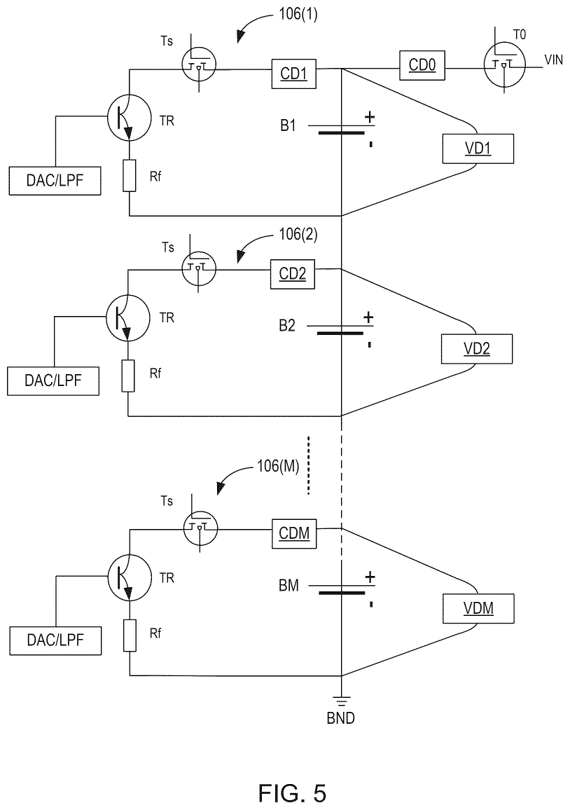

FIG. 5 is a schematic diagram of a still further implementation 500 of a system for monitoring and passive balancing in battery pack charging according to some non-limiting embodiments or aspects.

As shown FIG. 5, a passive balancing circuit (e.g., one or more, each, etc.) of the plurality of passive balancing circuits 106(1), 106(2), . . . 106(M) (e.g., each passive balancing circuit of the plurality of passive balancing circuits 106(1), 106(2), . . . 106(M), etc.) may further include a transistor TR, a resistor Rf (e.g., a fixed resistor, etc.), and/or a digital-to-analog converter (DAC) or a low pass filter (LPF). The transistor TR may be connected in parallel to the battery of that passive balancing circuit, and the resistor Rf may be connected in series to the transistor TR. The DAC may be configured to receive a digital control signal from control circuit 102 and generate, based on the digital control signal, an analog output signal. Alternatively, the digital control signal from control circuit 102 may include a Pulse Width Modulation (PWM) control signal that may be used to control the transistor TR by converting the PWM signal to an analog voltage signal using the LPF. A base of the transistor TR may be configured to receive the analog output signal from the DAC or the converted PWM signal as an input voltage. The DAC may be a standalone DAC or implemented within control circuit 102. For example, the transistor TR may be configured to operate in response to the input voltage, which enables the transistor TR to function as a switch, toggling or switching between an open circuit and closed circuit. When the passive balancing circuit is activated, the transistor TR, in conjunction with the resistor Rf, may form a closed circuit. By manipulating the input voltage of the transistor, an operating state of the transistor TR can be adjusted accordingly. This dynamic control over the operating state of the transistor TR may result in fluctuations in the passive balance current flowing through the passive balancing circuit. Consequently, the passive balancing circuit may achieve a desired adjustable or equivalent resistance required for effective passive balancing. Regardless of variations in current or load, this dynamic voltage division mechanism enables control circuit 102 to dynamically adjust an equivalent resistance of the transistor TR and the resistor Rf. Accordingly, excess power may be efficiently consumed, and overcharging of the battery may be effectively inhibited or prevented.

Still referring to FIG. 5, control circuit 102 may be configured to adjust the adjustable resistance of a passive balancing circuit of the plurality of passive balancing circuits 106(1), 106(2), . . . 106(M) connected in parallel to a battery of the plurality of batteries B1, B2, . . . BM by: controlling, based on the passive balance current measurement of the passive balance current through the passive balancing circuit and/or the voltage measurement of the plurality of voltages measurements of the voltage of the plurality of voltages measured across the battery of the plurality of batteries B1, B2, . . . BM, the digital control signal provided to the DAC or the converted PWM signal to control the input voltage of the transistor TR via the analog output signal to adjust the adjustable resistance of the passive balancing circuit.

For example, control circuit 102 may continually receive the passive balance current measurement of the passive balance current through that passive balancing circuit from the corresponding passive balance current detector of the plurality of passive balance current detectors CD1, CD2, . . . CDM that measures the passive balance current (e.g., Iₘ, 1≤m≤M, etc.) of the corresponding passive balancing circuit and/or the plurality of voltage measurements from the plurality of voltage detectors VD1, VD2, . . . VDM and continually calculate the adjustable resistance of that passive balancing circuit to provide via the transistor TR and the resistor Rf of that passive balancing circuit. By controlling the operating state of the transistor TR via the input signal, control circuit 102 may continually adjust the equivalent resistance value of the transistor TR and the resistor Rf to achieve the calculated adjustable or equivalent resistance of Rm for the passive balancing circuit. Accordingly, non-limiting embodiments or aspects of the present disclosure may ensure the safety and balance of the battery pack during the charging process.

As further shown in FIG. 5, in some non-limiting embodiments or aspects, a passive balancing circuit (e.g., one or more, each, etc.) of the plurality of passive balancing circuits 106(1), 106(2), . . . 106(M) may further include a switch Ts (e.g., a MOSFET, etc.) connected in series to the resistor Rf. Control circuit 102 may be configured to adjust the adjustable resistance of the passive balancing circuit of the plurality of passive balancing circuits 106(1), 106(2), . . . 106(M) connected in parallel to the battery by: activating the switch Ts. However, it is noted that the switch Ts may be optional because turning off the transistor TR may be electrically equivalent to turning off the switch Ts.

Non-limiting embodiments or aspects of passive balancing circuits as described herein may be versatile and can be applied to various charging models, different types of batteries, and varying numbers of series-connected packs. An applicability of non-limiting embodiments or aspects is not limited to a specific charging model, battery type, or pack configuration. This independent nature enables utilization in a wide range of applications.

Regardless of whether a charging model follows the constant current-constant voltage (CC-CV) paradigm or other charging strategies, non-limiting embodiments or aspects of passive balancing circuits as described herein can effectively balance the batteries within the battery pack, adapt to different battery chemistries, capacities, and voltage requirements, and ensure optimal performance and safety across diverse battery types.

Furthermore, non-limiting embodiments or aspects of passive balancing circuits described herein may remain flexible in accommodating various series-connected pack configurations. Whether there are a few batteries connected in series or a larger number, the circuits can handle the balancing requirements seamlessly. This scalability enables implementation in battery packs of different sizes, from small-scale applications to large-scale industrial systems.

Accordingly, non-limiting embodiments or aspects of the present disclosure exhibit versatility and compatibility, making them suitable for different charging models, battery types, and series-connected pack configurations, and the independent nature thereof enables broad applicability across diverse industries and applications.

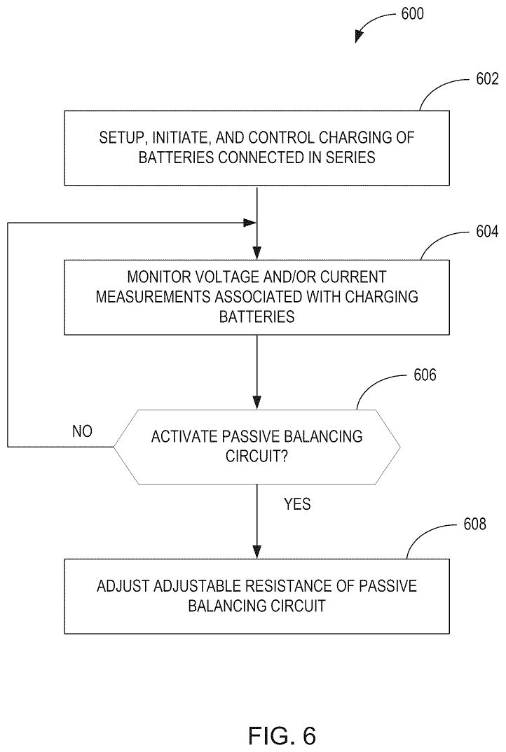

Referring now to FIG. 6, shown is a flow diagram for a method 600 for monitoring and passive balancing in battery pack charging, according to some non-limiting embodiments or aspects. The steps shown in FIG. 6 are for example purposes only. It will be appreciated that additional, fewer, different, or a different order of steps may be used in some non-limiting embodiments or aspects. In some non-limiting embodiments or aspects, a step may be automatically performed in response to performance or completion of a prior step.

As shown in FIG. 6, at step 602, method 600 includes setting up, initiating, and controlling charging of a plurality of batteries connected in series. For example, control circuit 102 may set up, initiate, and control charging of a plurality of batteries B1, B2, . . . BM connected in series.

Control circuit 102 may be configured (e.g., by a user via user input, etc.) to charge the plurality of batteries B1, B2, . . . BM in one or more charging stages. For example, control circuit 102 may store (e.g., in a memory, etc.) a plurality of charging stages in which the plurality of batteries B1, B2, . . . BM is to be charged. Control circuit 102 may be configured to set switching conditions (e.g., one or more preset voltage values across one or more batteries of the plurality of batteries B1, B2, BM, a preset current value of the charging current through the plurality of batteries B1, B2, . . . BM, etc.) for each charging stage of the plurality of charging stages and continually perform monitoring for the switching conditions and timely switching of the charging stages based on detection of the switching conditions.

Control circuit 102 may automatically calculate and set (e.g., store in a memory, etc.), for each charging stage of the one or more of charging stages (or for a current charging stage during charging), predefined conditions or thresholds for each passive balancing circuit of the plurality of passive balancing circuits 106(1), 106(2), . . . 106(M) and compare the predefined conditions or thresholds of that charging stage to the plurality of voltage measurements and/or the charging current measurement measured during charging in that charging stage to determine whether to activate a passive balancing circuit of the plurality of passive balancing circuits 106(1), 106(2), . . . 106(M) connected in parallel to a battery to adjust the adjustable resistance of the passive balancing circuit. For example, depending on the charging stage, the predefined conditions or thresholds can be based on reaching at least one of a preset voltage value, a preset current value, or any combination thereof. The activation condition for each passive balancing circuit can be set to be uniform or varied, depending on the requirements, or the condition of each battery.

After setting the one or more charging stages in which the plurality of batteries B1, B2, . . . BM is to be charged, control circuit 102 may initiate and/or control, based on a current charging stage of the one or more of charging stages (e.g., of a plurality of charging stages, etc.), at least one of a current source, a voltage source, or any combination thereof (e.g., charging interface or voltage source Vin, etc.) to provide at least one of the charging current through the plurality of batteries B1, B2, . . . BM, a charging voltage across the plurality of batteries B1, B2, . . . BM, or any combination thereof, to charge the plurality of batteries B1, B2, . . . BM according to parameters of the current charging stage. For example, if the current charging stage is a constant current charging stage, control circuit 102 my control the at least one of the current source, the voltage source, or any combination thereof (e.g., charging interface or voltage source Vin, etc.) to provide a constant charging current through the plurality of batteries B1, B2, . . . BM. As an example, if the current charging stage is a constant voltage stage control circuit 102 my control the at least one of the current source, the voltage source, or any combination thereof (e.g., charging interface or voltage source Vin, etc.) to provide a constant voltage across the plurality of batteries B1, B2, . . . BM.

As shown in FIG. 6, at step 604, method 600 includes monitoring voltage and/or current measurements associated with charging of the plurality of batteries connected in series. For example, control circuit 102 may monitor voltage and/or current measurements associated with charging of the plurality of batteries B1, B2, . . . BM connected in series. As an example, during the charging process, control circuit 102 may continually monitors a voltage of each battery and/or the charging current, control switching of charging stages based thereon, if applicable, and compare and analyze the current and/or voltage measurements against the preset activation conditions of each passive balancing circuit.

Control circuit 102 may receive, from the plurality of voltage detectors VD1, VD2, . . . VDM, the plurality of voltage measurements of the plurality voltages across the plurality of batteries B1, B2, . . . BM connected in series. Control circuit 102 may receive, from a passive balance current detector of a passive balancing circuit of the plurality of passive balancing circuits 106(1), 106(2), . . . 106(M), a passive balance current measurement of a passive balance current through that passive balancing circuit. Control circuit 102 may receive, from a charging current detector CD0, a charging current measurement of a charging current through the plurality of batteries B1, B2, . . . BM.

As shown in FIG. 6, at step 606, method 600 includes determining whether to activate a passive balancing circuit. For example, control circuit 102 may determine whether to activate a passive balancing circuit. As an example, control circuit 102 may determine, based on at least one of the following: a voltage measurement of the plurality of voltage measurements of a voltage of the plurality of voltages measured across a battery of the plurality of batteries B1, B2, . . . BM, the charging current measurement of the charging current measured through the plurality of batteries B1, B2, . . . BM, or any combination thereof, whether to activate the passive balancing circuit of the plurality of passive balancing circuits 106(1), 106(2), . . . 106(M) connected in parallel to the battery to adjust the adjustable resistance of the passive balancing circuit.

As shown in FIG. 6, at step 608, method 600 includes, in response to determining to activate the passive balancing circuit in step 606, adjusting an adjustable resistance of the passive balancing circuit. For example, control circuit 102 may, in response to determining to activate the passive balancing circuit in step 606, adjust an adjustable resistance of the passive balancing circuit. As an example, control circuit 102 may, in response to determining to activate the passive balancing circuit of the plurality of passive balancing circuits 106(1), 106(2), . . . 106(M) connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits 106(1), 106(2), . . . 106(M) connected in parallel to the battery. For example, when one or more batteries of the plurality of batteries B1, B2, . . . BM satisfy one or more preset activation conditions for a passive balancing circuit, control circuit 102 may automatically send a control signal to activate the corresponding passive balancing circuit. Control circuit 102 may calculate an adjustable or equivalent resistance for the passive balancing circuit based on the voltage measurement of the battery and the charging current measurement. Control circuit 102 may control the DAC or use the converted PWM signal via the LPF to control the transistor's operating state to achieve the calculated adjustable resistance (see e.g., FIG. 5), communicate on/off control signals to the resistor matrix to achieve the calculated adjustable resistance (see e.g., FIG. 3), and/or communicate control signals to adjust the resistance value of the variable resistor Rvar to achieve the calculated adjustable resistance, thereby enabling the passive balancing circuit to achieve a voltage shunt that inhibits or prevents overcharging or discharging of the individual battery connected in parallel thereto.

Control circuit 102 may determine that the plurality of batteries B1, B2, . . . BM (e.g., the entire battery pack, etc.) is fully charged when each battery of the plurality of batteries B1, B2, . . . BM reaches a preset voltage associated with that battery. In response to control circuit 102 determining that the plurality of batteries B1, B2, . . . BM is fully charged (e.g., that charging is complete, etc.), control circuit 102 may close or deactivate each passive balancing circuit of the plurality of passive balancing circuits 106(1), 106(2), . . . 106(M) to inhibit or prevent self-discharge of the battery pack. Control circuit 102 may communicate (e.g., via communication interface 214, etc.) a charging completion signal to an external computing device to provide for monitoring and management of the battery pack's status.

Control circuit 102 may perform additional operations on the battery pack, such as evaluating a performance and/or health status of the battery pack by measuring internal resistance, capacity, cycle life, and other parameters. Control circuit 102 may communicate (e.g., via communication interface 214, etc.) this information to an external computing device to provide for monitoring and management of the battery pack's performance and/or health status.

If a battery pack needs to be discharged or used, control circuit 102 can control and protect the battery back based on a specific discharge or usage mode and conditions. For example, control circuit 102 can set over-current protection, over-temperature protection, and under-voltage protection during discharge to safeguard the battery pack from damage and inhibit or prevent any adverse impact on performance and lifespan of the battery pack.

The following operational examples are for the purpose of illustration and description only and are not intended as a definition of the limits of the disclosed subject matter.

### Example 1

A battery pack including 15 series-connected batteries (e.g., the plurality of batteries B1, B2, . . . BM, etc.) is utilized to fulfill an application requiring a 54.75V DC voltage. Each battery is rated at 3.65V. To charge the battery pack, a charging management system according to non-limiting embodiments or aspects may be employed, which may include 15 passive balancing circuits (e.g., the plurality of passive balancing circuits 106(1), 106(2), . . . 106(M), etc.), 15 battery port voltage detectors (e.g., the plurality of voltage detectors VD1, VD2 . . . VDM, etc.), 1 charging current detector (e.g., charging current detector CD0, etc.), and a microprocessor (e.g., control circuit 102, etc.). Non-limiting embodiments or aspects for passive balancing management may be utilized for charging the battery pack.

Assuming a utilization of a CC-CV charging mode, switching conditions for the charging stages may be determined. A constant safe charging current of 10 A may be configured applied during the constant current stage, and switching to the constant voltage stage may be configured to occur when any battery's port voltage reaches 3V. The activation conditions for the passive balancing circuits may also be established. Since the target port voltage for each battery is 3.65V, the activation threshold for each passive balancing circuit may be set at 3.65V. When a battery's port voltage reaches 3.65V, the corresponding passive balancing circuit may be activated by the microprocessor.

The charging process may begin by applying the constant safe charging current of 10 A to the entire battery pack in the constant current stage. The charging current detector may ensure the accuracy and stability of the charging process while the battery port voltage detectors continually or continuously monitor the port voltages of the 15 battery ports. Once any one of the batteries reaches a voltage of 3V, the microprocessor may transition the charging of the entire battery pack to the constant voltage stage. A constant voltage of 54.75V may be applied to the entire battery pack for charging, and the microcontroller may monitor the system current and the port voltages of the 15 battery ports. According to the preset activation conditions for the passive balancing circuits, when any battery reaches a charging voltage of 3.65V, the microprocessor may activate a corresponding passive balancing circuit for that battery to safeguard the battery from overcharging. The remaining batteries, which may have not yet reached 3.65V, may continue to charge until all 15 batteries in the series reach the preset voltage value, which is the rated voltage of the entire battery pack (54.75V).

Assuming that the passive balancing circuit in this Example 1 utilizes a transistor with a fixed resistor to achieve dynamic resistance, such as implementation 500 illustrated in FIG. 5, with the transistor's input voltage range known to be 0-1V, when the input voltage is 0, the passive balancing circuit is closed. Once the input voltage exceeds the conduction threshold (e.g., 0.6V), the passive balancing circuit turns on. As the transistor operates in different states with changes in input voltage, the transistor exhibits different amplification factors on the current passing through the transistor. When greater voltage division is required, the microprocessor writes a higher value to the DAC in the passive balancing circuit, which is converted into an analog voltage. This enables the transistor to have a larger amplification factor, resulting in a larger current and providing increased voltage protection to the battery that has already reached 3.65V. By appropriately adjusting the input voltage of the transistor, the dynamic resistance of the passive balancing circuit can be fine-tuned, ensuring that the battery is neither overcharged nor discharged.

### Example 2

A battery pack includes 12 batteries (e.g., the plurality of batteries B1, B2, . . . BM, etc.), each with a voltage of 2.5V, for a total voltage of 30V, and utilizes multiple constant current stages for charging. In a first constant current stage, the batteries may be charged with a high but safe constant current of 5 A until the highest battery voltage reaches 2V. In the second stage, the charging current may switch to a constant current of 0.3 A, and real-time voltage detection is conducted on each battery to monitor voltages of the batteries. When any battery reaches 2.5V, a corresponding passive balancing circuit of that battery is activated by the microprocessor to inhibit or prevent overcharging. Because the charging current remains constant at 0.3 A, the resistance used to achieve the stable voltage of the battery without further charging or discharging can be calculated as R=V/I, which equals 8.33Ω. Assuming that the passive balancing circuit in this Example 2 utilizes a resistor matrix, such as implementation 300 illustrated in FIG. 3, the microprocessor may control the passive balancing circuit to achieve the equivalent resistance of 8.330 by connecting or disconnecting resistors in the resistor matrix. If there are changes in the port voltage or charging current, the microprocessor can perform re-detection and recalculation of the new equivalent resistance, using the existing resistor matrix to achieve the equivalent resistance in real-time for enhanced battery protection.

In each of Example 1 and Example 2, despite differences in a number of batteries in the battery pack, charging voltage, charging stage or mode, and the charging speeds of individual batteries, real-time monitoring and passive balancing circuits according to non-limiting embodiments or aspects may be employed to ensure that each battery is charged to the target value without being repeatedly overcharged or discharged throughout the entire process, thereby improving the safety, lifespan, and charging efficiency of the battery.

Accordingly, non-limiting embodiments or aspects of the present disclosure may provide systems, methods, and computer program products for real-time monitoring and efficient passive balancing during battery pack charging by incorporating dynamic resistance control to achieve improved voltage shunt. By integrating passive balancing circuits, battery port voltage detectors, a system or charging current detector, and/or a control circuit, non-limiting embodiments or aspects can adapt to diverse charging modes, battery types, and series-connected pack configurations. Non-limiting embodiments or aspects may enable real-time monitoring of battery voltage and system current, facilitating timely activation of the corresponding balancing circuits. The utilization of dynamic resistance ensures precise voltage shunt control, inhibiting or preventing overcharging or discharging of individual batteries, thereby enhancing the safety, longevity, and charging efficiency of battery packs. With exceptional real-time monitoring capabilities, dynamic resistance-based passive balancing, and compatibility with various charging scenarios, non-limiting embodiments or aspects may emerge as a game-changer for battery pack applications, offering unparalleled advantages in the field.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
a plurality of voltage detectors configured to determine a plurality of voltage measurements of a plurality voltages across a plurality of batteries connected in series;
a plurality of passive balancing circuits, wherein each passive balancing circuit of the plurality of passive balancing circuits is configured to be connected in parallel to a battery of the plurality of batteries, and wherein each passive balancing circuit of the plurality of passive balancing circuits has an adjustable resistance and includes a passive balance current detector configured to determine a passive balance current measurement of a passive balance current through that passive balancing circuit;
a charging current detector configured to determine a charging current measurement of a charging current through the plurality of batteries; and
a control circuit configured to:
receive the plurality of voltage measurements and the charging current measurement; and
determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate a passive balancing circuit of the plurality of passive balancing circuits connected in parallel to the battery to adjust the adjustable resistance of the passive balancing circuit; and
in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

2. The system of claim 1, wherein the passive balancing circuit of the plurality of passive balancing circuits connected in parallel to the battery further includes:
a plurality of resistors connected in parallel to each other and the battery; and
a plurality of switches corresponding to the plurality of resistors, wherein each resistor of the plurality of resistors is connected in series to a switch of the plurality of switches,
wherein the control circuit is configured to adjust the adjustable resistance of the passive balancing circuit of the plurality of passive balancing circuits connected in parallel to the battery by:
controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

3. The system of claim 2, wherein the plurality of switches includes a plurality of metal-oxide-semiconductor field-effect transistors (MOSFETs).

4. The system of claim 1, wherein the passive balancing circuit of the plurality of passive balancing circuits connected in parallel to the battery further includes:
a variable resistor connected in parallel to the battery; and
a switch connected in series to the variable resistor,
wherein the control circuit is configured to adjust the adjustable resistance of the passive balancing circuit of the plurality of passive balancing circuits connected in parallel to the battery by:
activating the switch of the passive balancing circuit; and
controlling, based on the passive balance current measurement of the passive balance current through the passive balancing circuit and the voltage measurement of the plurality of voltages measurements of the voltage of the plurality of voltages measured across the battery of the plurality of batteries, the variable resistor to adjust the adjustable resistance of the passive balancing circuit.

5. The system of claim 4, wherein the switch includes a metal-oxide-semiconductor field-effect transistors (MOSFET).

6. The system of claim 1, wherein the passive balancing circuit of the plurality of passive balancing circuits connected in parallel to the battery further includes:
a transistor connected in parallel to the battery;
a resistor connected in series to the transistor; and
a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and
wherein the control circuit is configured to adjust the adjustable resistance of the passive balancing circuit of the plurality of passive balancing circuits connected in parallel to the battery by:
controlling, based on the passive balance current measurement of the passive balance current through the passive balancing circuit and the voltage measurement of the plurality of voltages measurements of the voltage of the plurality of voltages measured across the battery of the plurality of batteries, the digital control signal provided to the DAC or the LPF to control the input voltage of the transistor via the analog output signal to adjust the adjustable resistance of the passive balancing circuit.

7. The system of claim 6, wherein the passive balancing circuit of the plurality of passive balancing circuits connected in parallel to the battery further includes:
a switch connected in series to the resistor, wherein the control circuit is configured to adjust the adjustable resistance of the passive balancing circuit of the plurality of passive balancing circuits connected in parallel to the battery by:
activating the switch, wherein the switch includes a metal-oxide-semiconductor field-effect transistors (MOSFET).

8. The system of claim 1, wherein the control circuit is configured to control charging of the plurality of batteries in a plurality of charging stages,
wherein the control circuit is configured to control, based on a current charging stage of the plurality of charging stages, at least one of a current source, a voltage source, or any combination thereof to provide at least one of the charging current through the plurality of batteries, a charging voltage across the plurality of batteries, or any combination thereof, to charge the plurality of batteries, and
wherein the control circuit is further configured to adjust the adjustable resistance of the passive balancing circuit of the plurality of passive balancing circuits connected in parallel to the battery based on the current charging stage of the plurality of charging stages.

9. The system of claim 8, wherein the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

10. A method comprising:
receiving, with at least one processor, from a plurality of voltage detectors, a plurality of voltage measurements of a plurality voltages across a plurality of batteries connected in series;
receiving, with the at least one processor, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance;
receiving, with the at least one processor, from a charging current, a charging current measurement of a charging current through the plurality of batteries;
determining, with the at least one processor, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and
in response to determining to activate the passive balancing circuit of the plurality of passive balancing circuits connected in parallel to the battery to adjust the adjustable resistance of the passive balancing circuit, adjusting, with the at least one processor, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

11. The method of claim 10, wherein the passive balancing circuit of the plurality of passive balancing circuits connected in parallel to the battery further includes:
a plurality of resistors connected in parallel to each other and the battery; and
a plurality of switches corresponding to the plurality of resistors, wherein each resistor of the plurality of resistors is connected in series to a switch of the plurality of switches,
wherein the control circuit is configured to adjust the adjustable resistance of the passive balancing circuit of the plurality of passive balancing circuits connected in parallel to the battery by:
controlling, based on the passive balance current measurement of the passive balance current through the passive balancing circuit and the voltage measurement of the plurality of voltages measurements of the voltage of the plurality of voltages measured across the battery of the plurality of batteries, the plurality of switches to adjust the adjustable resistance of the passive balancing circuit.

12. The method of claim 11, wherein the plurality of switches includes a plurality of metal-oxide-semiconductor field-effect transistors (MOSFETs).

13. The method of claim 10, wherein the passive balancing circuit of the plurality of passive balancing circuits connected in parallel to the battery further includes:
a variable resistor connected in parallel to the battery; and
a switch connected in series to the variable resistor,
wherein adjusting, with the at least one processor, the adjustable resistance of the passive balancing circuit of the plurality of passive balancing circuits connected in parallel to the battery includes:
activating, with the at least one processor, the switch of the passive balancing circuit; and
controlling, with the at least one processor, based on the passive balance current measurement of the passive balance current through the passive balancing circuit and the voltage measurement of the plurality of voltages measurements of the voltage of the plurality of voltages measured across the battery of the plurality of batteries, the variable resistor to adjust the adjustable resistance of the passive balancing circuit.

14. The method of claim 13, wherein the switch includes a metal-oxide-semiconductor field-effect transistors (MOSFET).

15. The method of claim 10, wherein the passive balancing circuit of the plurality of passive balancing circuits connected in parallel to the battery further includes:
a transistor connected in parallel to the battery;
a resistor connected in series to the transistor; and
a digital-to-analog converter (DAC) or a low pass filter (LPF) configured to receive a digital control signal from the control circuit and generate, based on the digital control signal, an analog output signal, wherein a base of the transistor is configured to receive the analog output signal from the DAC or the LPF as an input voltage, and
wherein adjusting, with the at least one processor, the adjustable resistance of the passive balancing circuit of the plurality of passive balancing circuits connected in parallel to the battery includes:
controlling, with the at least one processor, based on the passive balance current measurement of the passive balance current through the passive balancing circuit and the voltage measurement of the plurality of voltages measurements of the voltage of the plurality of voltages measured across the battery of the plurality of batteries, the digital control signal provided to the DAC or the LPF to control the input voltage of the transistor via the analog output signal to adjust the adjustable resistance of the passive balancing circuit.

16. The method of claim 15, wherein the passive balancing circuit of the plurality of passive balancing circuits connected in parallel to the battery further includes:
a switch connected in series to the resistor, wherein adjusting, with the at least one processor, the adjustable resistance of the passive balancing circuit of the plurality of passive balancing circuits connected in parallel to the battery includes:
activating, with the at least one processor, the switch, wherein the switch includes a metal-oxide-semiconductor field-effect transistors (MOSFET).

17. The method of claim 10, further comprising:
controlling, with the at least one processor, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and
wherein adjusting, with the at least one processor, the adjustable resistance of the passive balancing circuit of the plurality of passive balancing circuits connected in parallel to the battery is further based on the current charging stage of the plurality of charging stages.

18. The method of claim 17, wherein the plurality of charging stages includes at least one of the following: a constant current charging stage in which the charging current is controlled to be constant; a constant voltage stage in which the charging voltage is controlled; a trickle charging stage in which the plurality of batteries connected in series is fully charged and at least one of the charging current, the charging voltage, or any combination thereof is controlled to charge the plurality of batteries connected in series at a rate equal to a self-discharge rate of the plurality of batteries connected in series; a pulse width modulation (PWM) stage in which the at least one of the charging current, the charging voltage, or any combination thereof is controlled via a PWM signal; or any combination thereof.

19. A computer program product including a non-transitory computer readable medium including program instructions which, when executed by at least one processor, cause the at least one processor to:
receive, from a plurality of voltage detectors, a plurality of voltage measurements of a plurality voltages across a plurality of batteries connected in series;
receive, from a passive balance current detector of a passive balancing circuit of a plurality of passive balancing circuits, a passive balance current measurement of a passive balance current through that passive balancing circuit, wherein each passive balancing circuit of the plurality of passive balancing circuits is connected in parallel to a battery of the plurality of batteries, and wherein each passive balancing circuit of the plurality of passive balancing circuits has an adjustable resistance;
receive, from a charging current, a charging current measurement of a charging current through the plurality of batteries;
determine, based on at least one of the following: a voltage measurement of the plurality of voltage measurements of a voltage of the plurality of voltages measured across a battery of the plurality of batteries, the charging current measurement of the charging current measured through the plurality of batteries, or any combination thereof, whether to activate the passive balancing circuit of the plurality of passive balancing circuits connected in parallel to the battery to adjust the adjustable resistance of the passive balancing circuit; and
in response to determining to activate the passive balancing circuit of the plurality of passive balancing circuits connected in parallel to the battery to adjust the adjustable resistance of the passive balancing circuit, adjust, based on the passive balance current measurement of the passive balance current through the passive balancing circuit and the voltage measurement of the plurality of voltages measurements of the voltage of the plurality of voltages measured across the battery of the plurality of batteries, the adjustable resistance of the passive balancing circuit of the plurality of passive balancing circuits connected in parallel to the battery.

20. The computer program product of claim 19, wherein the program instructions, when executed by the at least one processor, further cause the at least one processor to:
control, based on a current charging stage of a plurality of charging stages in which the plurality of batteries is charged, at least one of a current source, a voltage source, or any combination thereof to provide at least one of the charging current through the plurality of batteries, a charging voltage across the plurality of batteries, or any combination thereof, to charge the plurality of batteries, and
wherein adjusting the adjustable resistance of the passive balancing circuit of the plurality of passive balancing circuits connected in parallel to the battery is further based on the current charging stage of the plurality of charging stages.
